(19) United States
(12) Patent Application Publication
(10) Pub. No.: US 2016/0092886 A1
(43) Pub. Date: Mar. 31, 2016

(54) METHODS OF AUTHORIZING A COMPUTER LICENSE

(71) Applicant: Nalpeiron Inc., Palo Alto, CA (US)

(72) Inventor: Roland Dwayne Ramey, Nolensville, TN (US)

(73) Assignee: NALPEIRON INC., Palo Alto, CA (US)

(21) Appl. No.: 14/501,218

(22) Filed: Sep. 30, 2014

(51) Int. Cl. G06Q 30/00

(52) U.S. Cl. CPC G06Q 30/018; G06Q 2220/18

(57) ABSTRACT

Systems and methods use features of an inode's or file identifier's (id) assignment, uniqueness and randomness, to fingerprint an end user device or system for authorization of a license. During the installation process of an operating system on an end user device certain directories and files created, that remain in place for the life of the installation, result in inodes or file ids that will be largely random as they depend, for example, on which files are installed and in what order their installation takes place. Since a modern operating system will have several processes occurring in parallel during installation the order in which files are installed will vary more or less randomly from system to system. To fingerprint the system a group of files that is fixed during the operating systems lifetime, such as system directories, are used to determine the inodes associated with these directories as represented by their inode number. The numbers are combined and hashed to provide a unique identifier for that OS installation and the associated end user device.

### FIELD

The systems and methods disclosed herein relate to authorizing software for use on a computer via a license. More particularly, the systems and methods disclosed herein relate to authorizing a computer license in which the computer license is reauthorized a number of times.

### BACKGROUND

Many software manufacturers in the market today require a purchaser and end user to obtain a license to use a software program or product. Some products contain a dialog box that appears during installation of the product with the license information. When an end user accepts the terms and conditions of the license, usually by clicking an “ACCEPT” button, the product is then installed on the computer and the product is authenticated or authorized.

An example of authorizing a product is disclosed in U.S. Pat. No. 5,490,216 to Richardson, entitled System for Software Registration (“the '216 patent”). Products are authorized by sending some type of Computer ID to a licensing authority, and/or customer or end user specific information such as name and/or credit card number. The licensing authority and end user then use an identical algorithm at each end to transform the Computer ID into an authorization key. According to the '216 patent, both algorithms will always process the same Computer ID exactly the same way. If the authorization key generated by the licensing authority and received by the end user's computer is identical to the one created on the end user's computer, the product is available to use. The uniqueness of each authorization key is based on aspects of the end user's computer, aspects of the program (such as a checksum), and/or end user specific information such as name, address, credit card number, etc.

A unique Computer ID (and/or purchaser ID) is necessary for this technology to produce massively different activation keys for each end user. Without the unique Computer ID, one activation key would work on all of the computers. Problems with this technique include that it limits how products are activated. Additionally, the system and methods of the '216 patent utilizes very long alphanumeric numbers that are difficult for human beings to manage, communicate, or manually enter.

Still further, the system and methods of the '216 patent opens up the activation process to serious security flaws. More particularly, one popular method for using illegal copies of products is by unlocking them with rogue activation key generators. The process described in the '216 patent makes this easy. For instance, once any key generator is copied, the copies can be used to generate activation keys for all products using that system, or if end users can get a copy they can use the copy to generate activation keys for products the end users are not entitled to use. This happens frequently as can be shown by doing a quick web search for popular products and the term “keygen.” Processes known in the prior art make it possible to produce a key generator by copying a section of the protected product (or protection DLL), since both the key generator and the protection produce the identical hash of the input data.

In the case of a company that sells copy protection, unless that company creates a new algorithm for each customer or end user, the same key generator can be used to generate activation keys for all customers or end users and all products. This is a serious weakness in the copy protection system. Reverse engineering a single product will result in a rogue activation key generator for multiple products.

If a publisher or licensing authority desires to lease or license a product, that product must be reactivated continuously on the same computer. Using existing technology, reactivation is either impossible or very difficult because the unique Computer ID will always be the same and the customer or end user information will be the same. As a result, the activation keys will always be the same and the end user can continuously reuse the same activation key, defeating the purpose of enforcing the lease or license.

Unique Computer IDs and activation keys are typically of the type: VY13V-249B5-A25BC-PBC43-648DG. Computer IDs and activation keys of this type are difficult to verbally transmit from end user to licensing authority as the letters B, C, P, G, and V sound very much the same and the differences can be lost over a telephone connection unless both parties are well versed in using phonetics such as are used by the military.

### SUMMARY

According to an aspect of the present disclosure, protection schemes for controlling access and copying of software offered under license may be implemented in software and/or computer licensing systems and methods. A locally stored license file may be locally modifiable by end user software but secure from outside tampering. Accordingly, the end user device may be able to verify that authorized software wrote a local file to storage and not some other device. The end user device may be configured to verify that the file was not properly written sometime in the past, or saved aside and later copied back into place. The end user device may also be capable of verifying that its local time has not been set back. According to an embodiment, this protection process may include three separate and distinct parts: creation of a computerID; securely writing a file to local storage; and securely reading the file in from local storage.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates an embodiment of a system architecture for implementing the systems and methods of authorizing a computer license;

FIG. 2 illustrates an embodiment of a method of creating a computerID;

FIG. 3 illustrates an embodiment of a method of securely writing a file to a local storage; and

FIGS. 4A-4C illustrate an embodiment of a method of securely reading a file in from a local storage.

### DETAILED DESCRIPTION

Detailed embodiments of the systems and methods are disclosed herein, however, it is to be understood that the disclosed embodiments are merely exemplary of the systems and methods, which may be embodied in various forms. Therefore, specific functional details disclosed herein are not to be interpreted as limiting, but merely as a basis for the claims and as a representative basis for teaching one skilled in the art to variously employ the systems and methods disclosed herein.

Generally, the systems and methods disclosed herein include and may be implemented within a computer system or network of computer systems having one or more databases and other storage apparatuses, servers, and additional components, such as processors, modems, terminals and displays, computer-readable media, algorithms, modules, and other computer-related components. The computer systems are especially configured and adapted to perform the functions and processes of the systems and methods as disclosed herein.

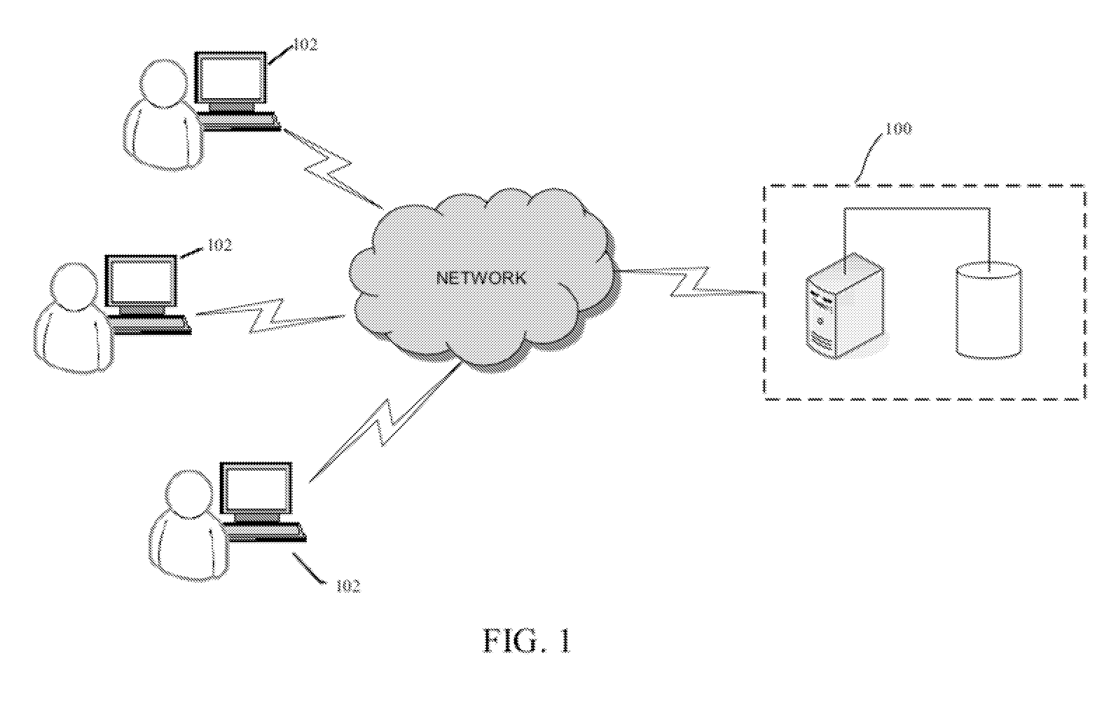

In an illustrative embodiment, the systems and methods disclosed herein relate to software and/or computer licensing implementations, and in particular protection schemes for controlling access and copying of software offered under license. A system architecture for implementing the systems and methods of authorizing a computer license according to an illustrative embodiment is described with reference to FIG. 1. As illustrated, the system includes at least one licensing authority 100 such as may be implemented on a server computer configured to deliver content, programs and or provide access to software of various sorts, and at least one end user device 102 such as an electronic client-system in communication with the at least one licensing authority 100. The licensing authority 100 illustratively includes a processor, encryption processor, database, module, server, computer system or network of computer systems associated with a publisher or licensor of the product that can access, provide, transmit, receive, and modify information over the wired or wireless network.

The end user device(s) 102 may be continually or periodically connected to the licensing authority 100 or separate/disconnected from the licensing authority 100 over a wired or wireless network, such as the Internet. The end user device(s) 102 may be an electronic communication device such as but not limited to a computer, personal digital assistant (PDA), cellular or mobile phone, and other devices that can access, provide, transmit, receive, and modify information over wired or wireless networks. The end user device(s) 102 illustratively includes a processor, decryption processor, database, module, server, computer system or network of computer systems. The network may be a local area network or a wide area network and may be a private or public network of any size or scope. In an illustrative embodiment, the network is the Internet.

According to an aspect of the present disclosure, protection schemes for controlling access and copying of software offered under license may be implemented in software and/or computer licensing systems and methods. A locally stored license file may be locally modifiable by end user software but secure from outside tampering. Accordingly, the end user device may be able to verify that authorized software wrote a local file to storage and not some other device. The end user device may be configured to verify that the file was not properly written sometime in the past, or saved aside and later copied back into place. The end user device may also be capable of verifying that its local time has not been set back. According to an embodiment, this protection process may include three separate and distinct parts: creation of a computerID; securely writing a file to local storage; and securely reading the file in from local storage.

As an illustration, a secure file may be used as local storage of a software license. The software license might arrive in an encrypted message passed to the end user device from a licensing server. It is often necessary to verify that the license belongs to the end user and was not intended for another end user device. This may be done by comparing a computerID in the license to one locally calculated on the end user device. Typically, such an ID is created from fingerprinting the hardware present in the local system. Fingerprinting hardware, as known in the art, to form a computerID suffers from a number of drawbacks. For instance, some hardware, particularly hard disks, require elevated permissions before device-specific identification can be obtained. Also a computerID based on hardware will change when the hardware is updated rendering the current license invalid. Further, the types of hardware present on a device varies greatly, so the algorithms used to create a hardware based computerID must change from system to system. According to the disclosure, a solution to these hardware fingerprinting problems includes using an ID based not on hardware but on specifics of the root file system.

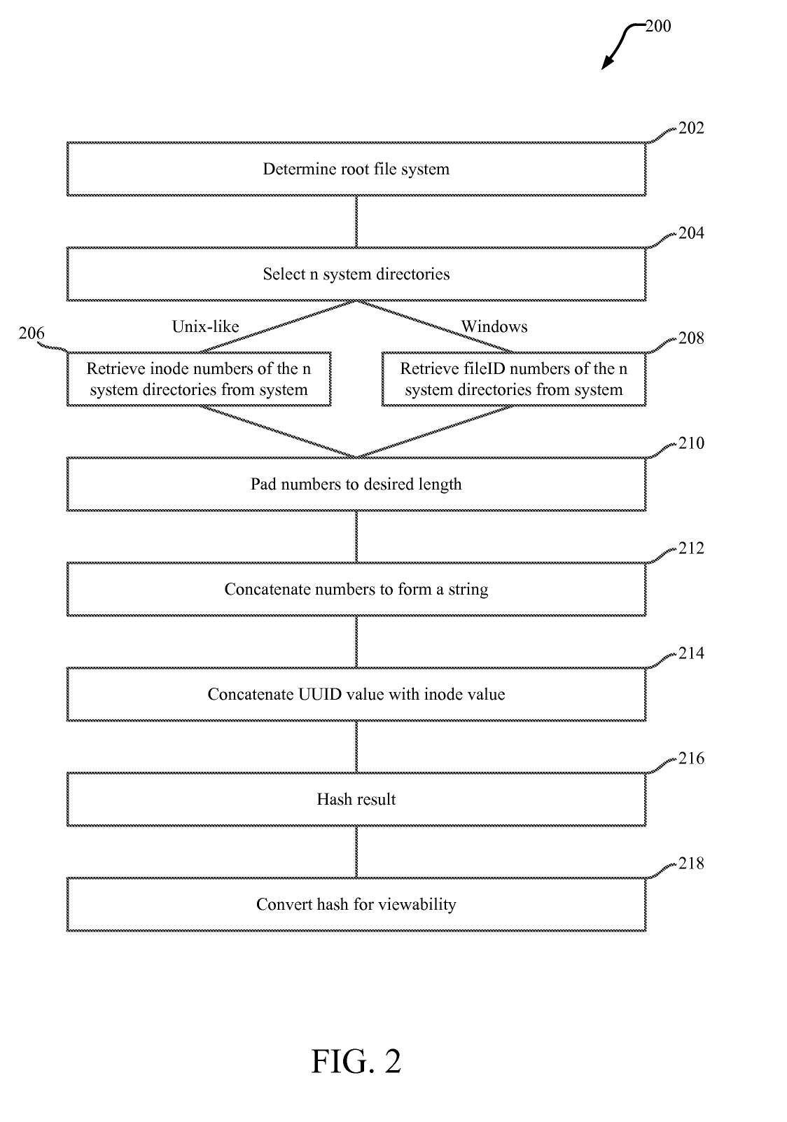

A method 200 for creating a computerID based on the root file system of a computer is disclosed with reference to FIG. 2. At block 202 the root filesystem is determined. This may include determining which filesystem contains the root directory of the operating system. At block 204 “n” number of system directories are selected. These may include directories created during the installation of the operating system and required for the operating system to function, thus ensuring the directories will exist and remain in place throughout the operating system's existence. Examples of such directories on a Unix-like system include, for example, /etc, /bin, and /lib. On a Windows system, the directories may include those defined by system variables such as CSIDL_COMMON_DOCUMENTS and CSIDL_WINDOWS, for example. Modes or fileIDs associated with these directories will be unique on the filesystem, depend on the peculiarities of the operating system installation, and remain constant for the life of the directories. Mode numbers of these directories may be retrieved using a system call such as “stat”, for example. FileIDs may be retrieved using, for example, “GetFileInformationByHandle” on a new technology file system (“ntfs”) filesystem.

If the system is Unix or Unix-like, such as Linux, OSX, or BSD, for example, inode numbers of the n number of system directories are retrieved, illustrated as 206. A file's inode is a small amount of space set aside on the file system to contain meta-information about the file. This information includes such things as file ownership, file permissions, file modification time, and pointers to the actual data of the file, for example. An inode may be referred to by a number, which is the offset of the inode into an index or table of inodes stored at a known location.

The inode has several features. For instance, on a given file system the inode associated with a file or directory is unique. Accordingly, an inode is associated with a single file or directory and no other file or directory on that file system will have the same inode number. The assignment of an inode to a file may be a complex algorithm and also may be random. Typically, a list of free inodes is kept by the kernel. The kernel searches the list and assigns a new file to the first free inode it comes across. If this list is empty, the kernel searches the inode table for a free inode and assigns it. On a running system, the procedure is complicated by buffered input and output, delays in updating the free inode list, and system interrupts, for example. Thus even in a fairly proscribed event such as installation of an operating system, what inode is assigned to which file varies greatly. Once an inode is assigned to a file it remains assigned for the life of the file. Thus, a file's inode is permanent and unchanging.

If the system is in the NTFS file system on Windows, the fileID numbers of the n number of system directories is retrieved, illustrated as 208. The fileID is a unique numeric identifier associated with each file or directory on a given volume. Since the fileID is guaranteed to be unique, it shares the properties of an inode that make it useful for constructing a unique ID. The fileID also has the property that it will remain constant over the life of the file. While the ReplaceFile function can be used to copy a fileID, it is the ID of the replacing file not the replaced file that is preserved. These three properties make the fileID suitable for constructing a unique computerID.

At block 210 the retrieved inode and fileID numbers may be padded to a desired length. In the case of inodes, the number may run from 0 to the hundreds of millions or more. At block 212 the padded numbers are concatenated, or linked together in a chain or series, in a fixed order to produce an identifying string that is unique to the operating system installation for a given device. At block 214 a universally unique identifier, or UUID, value may be concatenated with the inode value. At block 216 the string may be hashed to provide a computerID having a fixed length using any of various standard hashing functions known in the art, such as MD5, SHA-256, SHA-512, or the like. At block 218 the hashed string may be converted for viewability purposes. Such hashing may include hashing the string to a hexadecimal or base64 representation, thereby ensuring it is easily printable and transmittable.

A method for securely storing and updating a local file using the computerID, created using the method 200 detailed above, may include two parts: writing or creating the file and reading the file.

Storing the computerID in the file solves the problem of unauthorized license assignment by uniquely identifying the end user device for which the license is intended. Ensuring the file has not been tampered with may be solved with standard encryption techniques known in the art. For example, the Rijndael, Serpent, or Twofish encryption schemes may be used. Historically, a license could be created with a fixed number of uses, but the original license could be stored and copied back into place at a later date. This would result in no decryption occurring and the contents of the license would be unchanged, resulting in the end user having the full number of software uses available again. The present disclosure, using the file's inode or fileID, provides a secure method of determining that the file was written by authorized software.

If the software always looks in the same path for the same file an attacker using a replay scheme will have to copy the file off to a new location. If left in place, the client's software will correctly decrement the number of available uses in the example above. However, having copied the file the operating system will assign to it a new inode or fileID. When the saved file is moved back to its original location its new inode will not match the inode written into the file and the file will be deemed invalid.

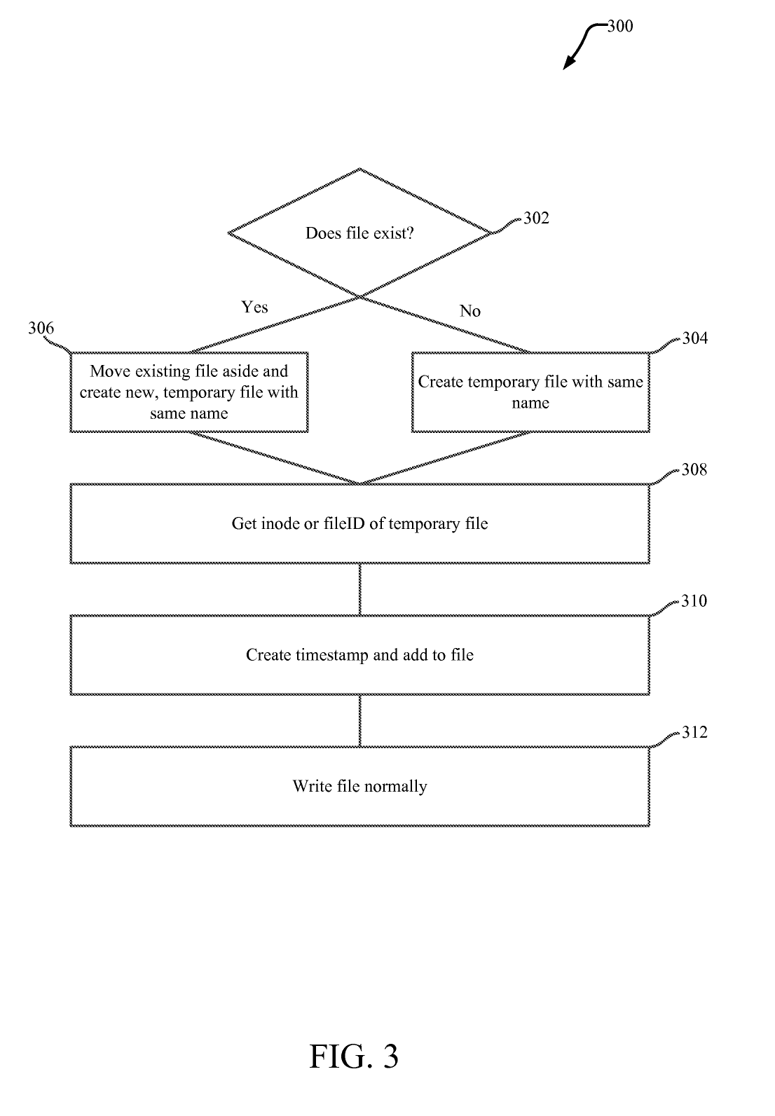

A method 300 for securely storing a local file using the created computerID is described with reference to FIG. 3. At block 302 the file's existence is checked. If the file does not exist, a temporary file is created with the same name as the original file so the file's inode or fileID can be obtained, illustrated as block 304. Such obtaining of the inode may occur using system calls, such as “stat” or “GetFileInformationByHandle”, for example. If the file does exist, the file is moved aside and a new, temporary file with the same name is created, illustrated as 306. At block 308 the inode or fileID of the temporary or new, temporary file is obtained. This ensures every new file write is protected with a new and different inode or fileID. At block 310 the newly obtained inode or fileID and a timestamp created from the current system time is added to the information that will be written to the file. At block 312 the contents of the file are written out and the file is closed.

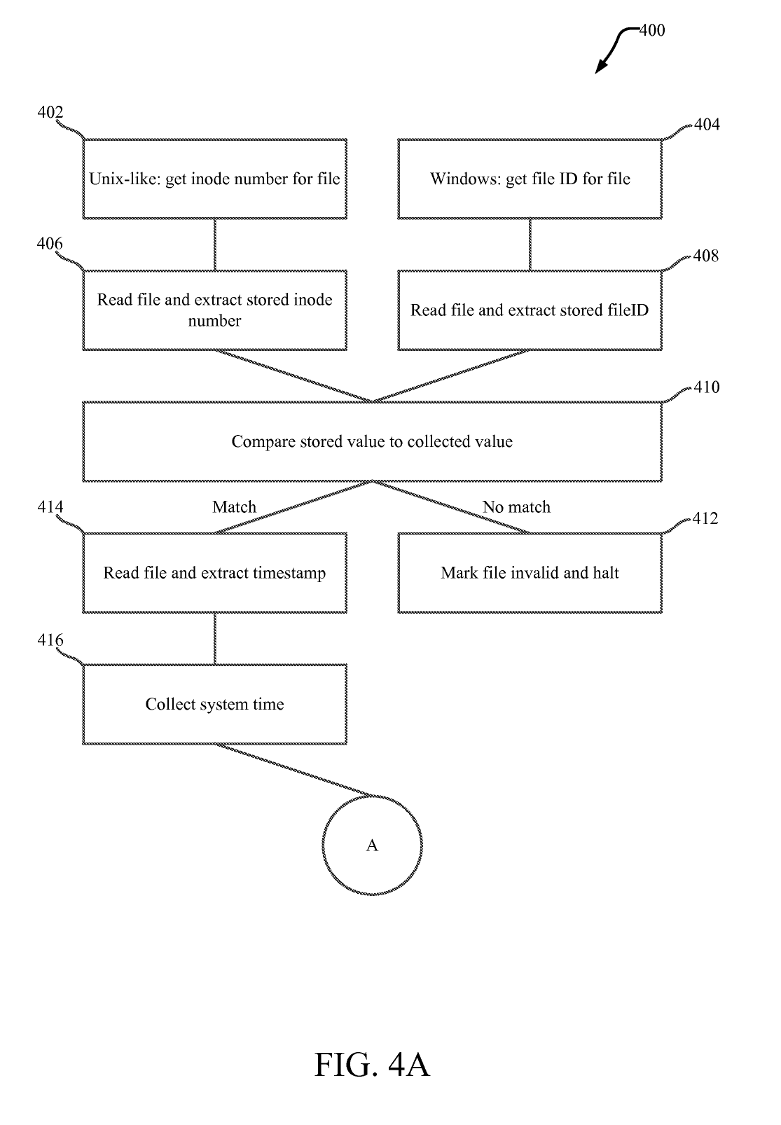

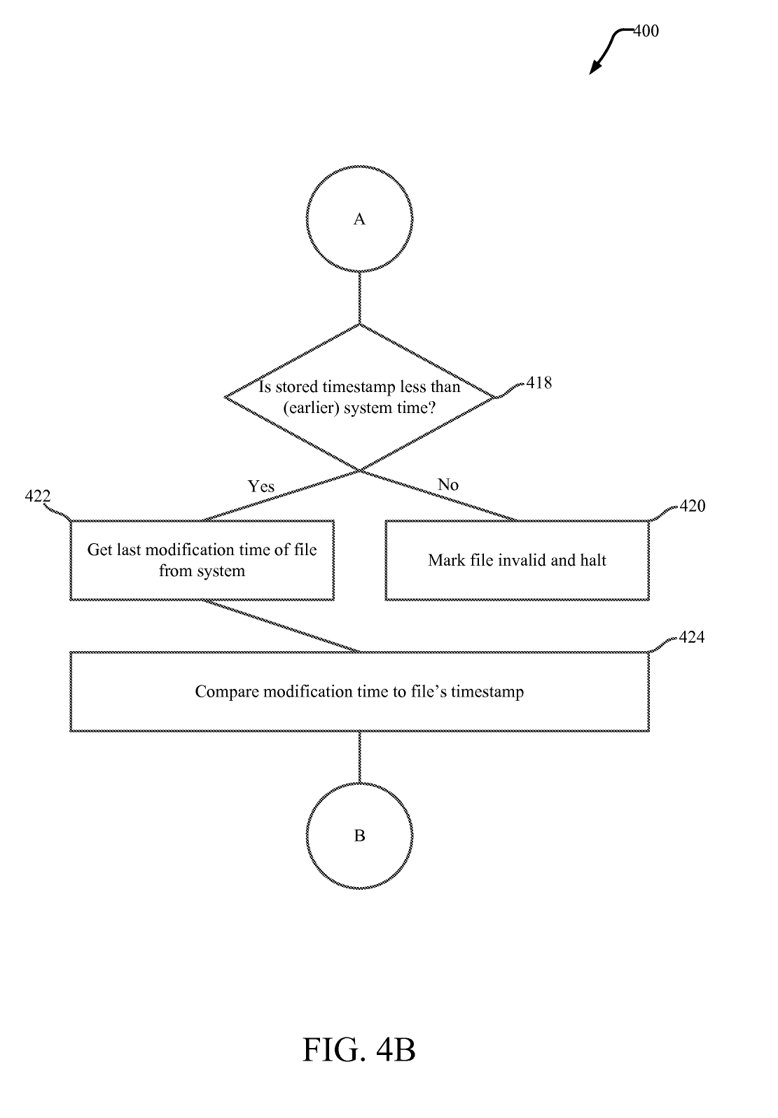

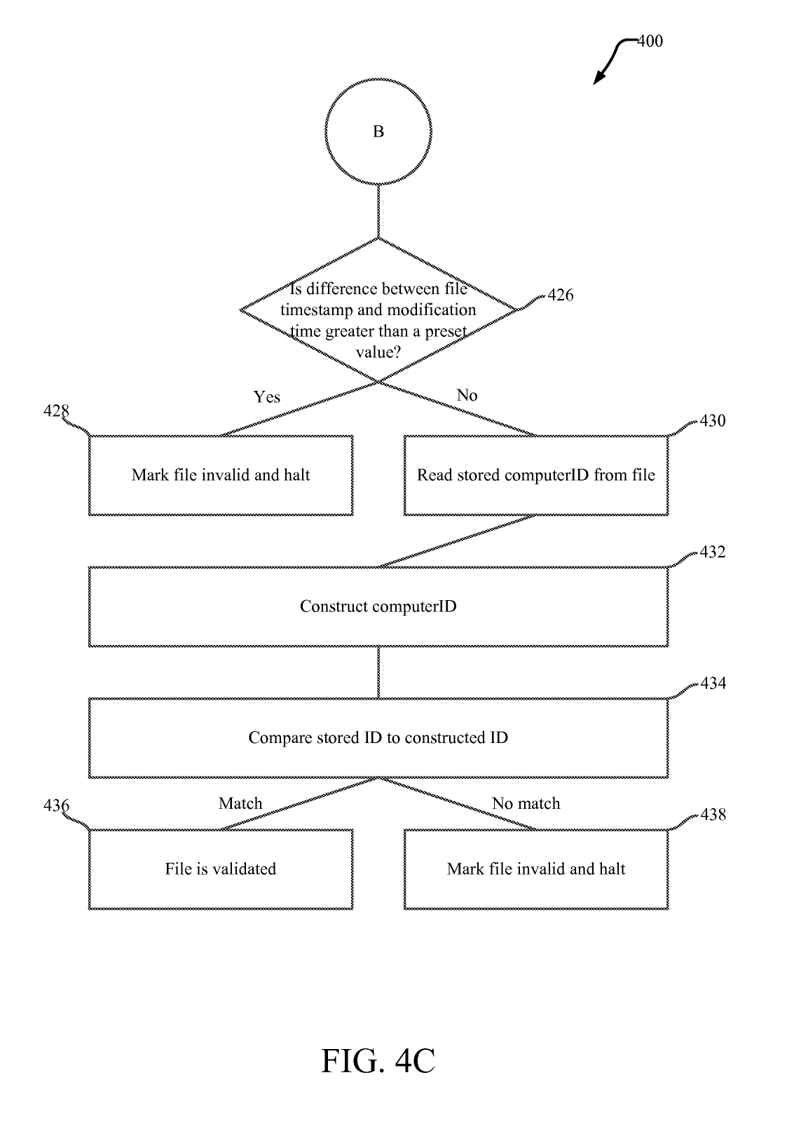

A method 400 of securely reading a local file using the created computerID is described with reference to FIGS. 4A-4C. When reading a file, it may be verified that the file was written by authorized software, that the file is not from the past and time-shifted, that the computer's system time is valid, and that the file originated on the end user device, for example. Before the file is opened for reading, the file's inode or fileID may be obtained, illustrated as blocks 402 and 404. Such obtaining of the inode or fileID may occur using system calls, such as “stat” or “GetFileInformationByHandle”, for example. At blocks 406 and 408 the file is read and the inode number or fileID stored within the file is extracted. At block 410 the stored inode number or fileID is compared to the inode number or fileID of the actual file. If the inodes or fileIDs do not match, the file is rejected as invalid and reading of the file is halted/discontinued, illustrated as 412. If the inodes or fileIDs match, the timestamp is read from the file, illustrated as 414, and the system time may be collected, illustrated as 416.

At decision point 418 (FIG. 4B) it is determined whether the stored timestamp is less than the earlier system time. If the timestamp is not less than the earlier system time, the file is marked invalid and reading of the file is halted/discontinued, illustrated as 420. If the timestamp is less than the earlier system time, the last modification time of the file may be obtained from the system, illustrated as 422. The last modification time may be the time the software last wrote to the file. Thus, it should be approximately equal to the timestamp written into the file barring any time change that may have occurred since the last write. At block 424 the last modification time of the file is compared to the file's timestamp.

At decision point 426 (FIG. 4C) it is determined whether the difference between the file timestamp and the last modification time is greater than a preset value, which is used to account for mis-set local clocks and to adjust for time changes and time zones. For example, the preset value may be an hour. According to multiple embodiments, a preset value of up to 24 hours may be used. If the difference between the current system time and the timestamp is greater than the preset value the file is marked invalid and reading of the file is halted/discontinued, illustrated as block 428. If the difference between the current system time and the timestamp is not greater than the preset value the computerID is read from the file, illustrated as 430. At block 432, the computerID may be freshly constructed on the system. At block 434 the stored computerID and freshly constructed computerID are compared. If the stored computerID matches the freshly constructed computerID, the file is validated, illustrated as block 436. However, if the stored computerID does not match the freshly constructed computerID, the file is marked invalid and reading of the file is halted/discontinued, illustrated as block 438.

It should be appreciated that it is possible that a computer's fingerprint will change during an upgrade of the operating system. To account for this, it is possible in an embodiment to retain the fingerprints associated with a system in a list, and use the list of fingerprints to identify the system for purposes of authentication.

It should be appreciated that while inodes or file ids have associated features such as ownership, file type, file permissions, etc, all or some combination of the information of the inodes or file ids may be used in implementing the systems and methods disclosed herein. Further, while “files” may be used herein, it should be appreciated that the term may refer to files or directories or other identifiable sets of files or directories.

Similarly, while the features described herein relating to inodes or file ids such as assignment, uniqueness and randomness are used herein in accordance with the disclosure to fingerprint a system in a manner disassociated from hardware, it should be appreciated that software aspects with similar attributes and/or inhering in other than Unix-like or Windows software systems may be used in practicing systems and methods according to the disclosure.

While the systems and methods disclosed herein have been described and illustrated in connection with certain embodiments, many variations and modifications will be evident to those skilled in the art and may be made without departing from the spirit and scope of the disclosure. The disclosure is thus not to be limited to the precise details of methodology or construction set forth above as such variations and modification are intended to be included within the scope of the disclosure.

What is claimed is:

1. A method of authorizing a license for an end user device comprising:
receiving a unique computerID based upon a root file system of the end user device;
writing a file to a local storage of the end user device; and
reading the file in from the local storage of the end user device to authorizing the license for the end user device.

2. The method of claim 1 wherein the unique computerID is based upon an inode.

3. The method of claim 1 wherein the unique computerID is based upon a fileID.

4. The method of claim 2 wherein the unique computerID includes a concatenated inode.

5. The method of claim 2 wherein the unique computerID includes a universally unique identifier value.

6. The method of claim 1 wherein the unique computerID is hashed.

7. The method of claim 6 wherein the hashed unique computerID is converted into a representation selected from the group consisting of hexadecimal and base64.

8. A system for authorizing use of a product on an end user device, comprising:
a licensing authority computing device including at least one processor and a memory device including instructions operable to be executed by said at least one processor to perform a set of actions, said at least one processor including:
a licensing authority processor configured to receive character strings from said one or more end user devices, said character strings having a unique computerID based upon a root file system of the end user device;
an encryption processor in communication with said at least one licensing authority processor and configured to encrypt at least a portion of each of said character strings; and
a decryption processor in communication with said at least one licensing authority processor, said decryption processor configured to decrypt said encrypted portion of said character strings,
said licensing authority computing device providing authorization for said end user device to access said product based on a matching of the unique computerID and the root file system of the end user device.

9. The system of claim 8 wherein the unique computerID includes an inode value.

10. The system of claim 8 wherein the unique computerID includes a fileID.

11. The system of claim 8 wherein the unique computerID includes a universally unique identifier.

12. The system of claim 8 wherein the unique computerID includes a universally unique identifier concatenated with one of an inode value or a fileID.

13. A method of securely accessing a licensed product on an end user device comprising the steps of:
retrieving a unique identifier for a product file from the end user device, the unique identifier including one of an inode number or fileID;
extracting a stored unique identifier stored within the product file, the stored unique identifier including one of a stored inode number or a stored fileID;
comparing the unique identifier to the stored unique identifier;
reading the stored unique identifier from the product file;
creating a constructed unique identifier, the constructed unique identifier including one of the inode number or the fileID;
comparing the stored unique identifier to the constructed unique identifier; and
validating the product file.

14. The method of claim 13 wherein the stored unique identifier includes a timestamp.

15. The method of claim 14 wherein the timestamp is specific to a current system time of the end user device when the product file was stored on the end user device.

16. The method of claim 14 further comprising the step of:
extracting the timestamp from the stored unique identifier.

17. The method of claim 16 further comprising the step of:
collecting a system time from the end user device.

18. The method of claim 18 further comprising the step of:
retrieving a modification time of the product file from the end user device, the modification time being the last time the product file was modified on the end user device.

19. The method of claim 18 further comprising the step of:
comparing the modification time to the timestamp.
